(19) United States
(12) Patent Application Publication
(10) Pub. No.: US 2017/0065892 A1
(43) Pub. Date: Mar. 9, 2017

(54) METHOD AND APPARATUS FOR RETENTION OF CONSUMERS OF NETWORK GAMES AND SERVICES

(71) Applicant: InterDigital Technology Corporation, Wilmington, DE (US)

(72) Inventor: Shoshana Loeb, Philadelphia, PA (US)

(21) Appl. No.: 15/119,988

(22) PCT Filed: Jan. 29, 2015
(86) PCT No.: PCT/US2015/013532

§ 371 Date: Aug. 18, 2016

Related U.S. Application Data
(60) Provisional application No. 61/945,522, filed on Feb. 27, 2014.

(51) Int. Cl. A63F 13/79; A63F 13/358; G07F 17/32

(52) U.S. Cl. CPC A63F 13/79; G07F 17/3244; A63F 13/358; A63F 2300/535

(57) ABSTRACT

The disclosure pertains to methods and apparatus for identifying patterns that occur in game play of online games or consumption of other online services, such as massively multiplayer online role playing games (MMORPGs), that tend to lead to a person abandoning the game or service, detecting the occurrence of such patterns during play or consumption, and taking remedial actions to incentivize continued playing of the game or consumption of the service. The patterns may comprise one or a combination of game play events (e.g., losing a game or the players avatar dying) and network events (e.g., jitter).

### RELATED APPLICATIONS

This application is a non-provisional application of U.S. provisional patent application No. 61/945,522, filed Feb. 27, 2014, the contents of which are incorporated herein fully by reference.

### FIELD OF THE INVENTION

This application relates to methods and apparatus for preventing consumers of network-based services, such as players of online games, from abandoning the game or service due to the occurrence of sub-optimal experiences.

### BACKGROUND

Developing, offering, and operating an online game, such as a massively multiplayer online role playing game (MMORPG), typically is a major undertaking. The business model for MMORPGs has evolved over the years. In 2009 and 2010, for example, several major game providers switched, or announced that they would switch, from a “pay-to-play” monthly subscription-based business model to a “free-to-play” business model in which they would offer a micro-transaction shop where players can buy virtual goods for real money. In the case of another major MMORPG provider, although only 10% of its free-to-play players bought anything, the average revenue for each of those paying users was $50 per month, which was more than three times the former monthly subscription fee. This particular MMORPG offers a free-to-play model up to level 20 of the game, presumably to hook players on the game. Both the pay-to-play and free-to-play business models can be successful revenue generators because players become invested in the game and continue to play the game for a lengthy duration, generating profit over time through their monthly fees (in the case of pay-to-play games) and through voluntary purchase transactions (in the case of both pay-to-play and free-to-play games). Such voluntary transactions can be as simple as purchasing more “lives” or new or more advanced game accoutrement, such as weapons, armor, or vehicles, etc. Moreover, most games require a large number of simultaneous players to provide challenging and enjoyable player experiences.

However, studies show that online game providers almost universally experience a decline in the number of players as a game matures. As was reported by Chambers et at (2010) [4], who studied ways to characterize online games, game popularity follows a power-law. Particularly, players have no tolerance for busy servers. Further, player churn is substantial and increases over time. Additionally, players change their play behavior in measurable ways when they are about to quit altogether. This is consistent with the results reported earlier by Feng et at (2007) [2] who provided an early long-term analysis of MMORPGs. They also showed that player churn increases as a game matures and that content updates have only a slight impact on growth of player population. They also showed that inter-session time (i.e., the time between playing sessions) provided a reasonable metric for identifying players that are about to quit playing a particular game altogether.

It has been speculated that the Quality of Experience (QoE) of the player is one of the key parameters that impacts player retention. Studies have been conducted to uncover the various end-to-end variables that impact player retention and hence impact retention. To that end, Chen et al. (2009) [1] conducted a study on the impact of network delays and network loss on player QoE. The results indicate that both network delay and network losses, such as jitter and packet loss significantly affect a player's decision to leave a game prematurely, e.g., the player quits a few minutes after joining a game. Furthermore, Chen et al. [1] showed that it is feasible to predict whether players will quit prematurely based on the network conditions that they experienced and proposed a model that can determine the relative impact of different types of network impairment (e.g., delay, jitter, packet loss).

Debeauvais et at (2011) [3] studied player commitment and retention in the World of Warcraft™ (WoW) game. They introduced three metrics, namely, weekly play time, stop rate, and how long respondents had been playing WoW. A quantitative analysis showed how WoW efficiently wielded powerful retention systems as the game designers leveraged the desire of the players for achievement and social play. Therefore, for this game, including friends, partners, and family members from real-life into the game proved to be an especially good mechanism for increased player retention.

### SUMMARY

In accordance with one aspect, the invention pertains to methods and apparatus for operating a game played by a multiplicity of players over a communication network comprising storing patterns of events that correlate to a risk of a player abandoning game play of the game (Risk Patterns), detecting the occurrence of patterns of events associated with a player of the game during game play that correspond to any of the Risk Patterns, and, responsive to occurrence of a pattern of events associated with the during game play that corresponds to a Risk Pattern, taking an action adapted to prevent the player from abandoning game play.

In accordance with another aspect, the invention pertains to methods and apparatus for providing a service over a communication network to a consumer of the service comprising detecting the occurrence of patterns of events during consumption of the service by a consumer that correspond to patterns of events that correlate to a risk of the consumer ceasing consumption of the service (Risk Patterns) and responsive to occurrence of a pattern of events during consumption of the service that corresponds to a Risk Pattern, taking an action adapted to prevent the consumer from ceasing consumption of the service.

In accordance with yet another aspect, the invention pertains to methods and apparatus for retaining consumers of a service provided over a communication network comprising a memory, a network pattern acquisition module configured to detect network-based events and determine and store in the memory patterns of network-based events that correlate to a risk of a consumer of the service decreasing consumption of the service, a consumer behavioral pattern acquisition module configured to detect consumer behavior-based events and determine and store in the memory patterns of consumer behavior-based events that correlate to a risk of a consumer of the service decreasing consumption of the service, a composite pattern creation module configured to analyze the stored patterns of network-based events that correlate to a risk of a consumer of the service decreasing consumption of the service and the stored patterns of player behavior-based events that correlate to a risk of a consumer of the service decreasing consumption of the service and determine and store composite patterns comprised of a plurality of network-based events and/or player behavior-based events that correlate to a risk of a consumer of the service decreasing consumption of the service (Composite Risk Patterns), a pattern detection module configured to detect the occurrence of patterns of events associated with a consumer of the service during consumption of the service that correspond to any of the Composite Risk Patterns, and a consumer contact module configured to take an action adapted to prevent the consumer from decreasing consumption of the service responsive to detection of an occurrence of a Composite Risk Pattern during consumption of the service.

### BRIEF DESCRIPTION OF THE DRAWINGS

A more detailed understanding may be had from the following description, given by way of example in conjunction with the accompanying drawings wherein:

FIG. 1 is a block diagram of a Player Retention System and related network elements in accordance with an exemplary embodiment of the invention;

FIG. 2 is a process flow diagram showing pattern detection and creation in accordance with an exemplary embodiment of the invention;

FIG. 3 is a signal flow diagram of pattern detection and response in accordance with an exemplary embodiment of the invention;

FIG. 4A is a system diagram of an example communications system in which one or more disclosed embodiments may be implemented;

FIG. 4B is a system diagram of an example wireless transmit/receive unit (WTRU) that may be used within the communications system illustrated in FIG. 4A; and

FIGS. 4C, 4D, and 4E are system diagrams of example radio access networks and example core networks that may be used within the communications system illustrated in FIG. 4A.

### DETAILED DESCRIPTION

A detailed description of illustrative embodiments will now be provided with reference to the various figures. Although this description provides a detailed example of possible implementations, it should be noted that the details are intended to be exemplary and in no way limit the scope of the application. In addition, the figures may illustrate message sequence charts, which are meant to be exemplary. Other embodiments may be used. The order of the messages may be varied where appropriate. Messages may be omitted if not needed, and, additional flows may be added.

In view of the huge investment typically required to develop, market and host a successful MMORPG, the present disclosure focuses on methods and apparatus for player retention, including ways for gathering patterns of server, network(s), and player behavior that correlate with player departure, and then applying them to detect and react to such patterns.

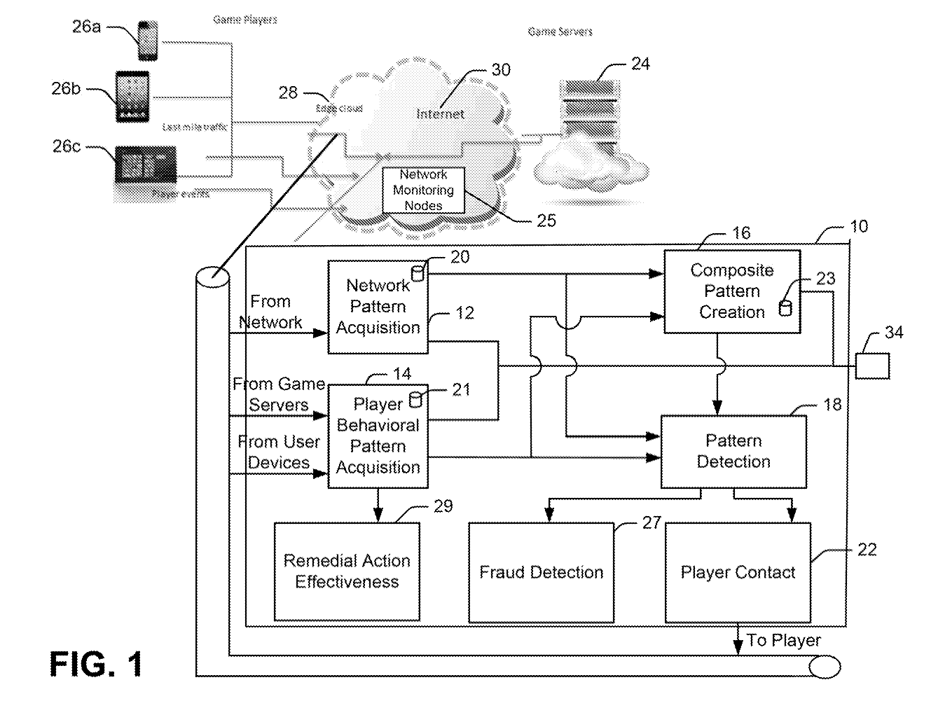

In accordance with an embodiment, a Player Retention System is provided that proactively addresses these player retention issues. With reference to FIG. 1, the Player Retention System 10 has four modules, namely, a Network Pattern Acquisition module 12, a Player Behavioral Pattern Acquisition module 14, a Composite Pattern Creation module 16, and a Pattern Detection module 18. Each of these modules will be described in more detail below. The modules are herein described in terms of the functions that they perform. Therefore, it will be understood that the modules shown in FIG. 1 do not necessarily correspond to different physical structures. In some embodiments, for instance, Player Retention System 10 and its module parts may be comprised entirely of software running on a single computer, such as a game server. In other embodiment, the Player Retention System 10 may be functionally split between several game servers (or other computers or processors). Those splits need not even necessarily be according to the modules shown in FIG. 1. In yet other embodiments, the Player Retention System and the modules of the Player Retention System may be implemented in part or in whole by dedicated hardware or any combination of hardware and software, including merely as some examples microprocessors, processors, state machines, logic circuits, Field Programmable Gate Arrays (FPGAs), memory and storage chips, analog circuitry, digital circuitry, etc.

The Network Pattern Acquisition module 12 acquires network traffic events that are associated with degradation of QoE of the players and hence affect player abandonment. Such events may include, for instance, network latency, jitter, and packet loss. Module 12 mines the event data to detect patterns of network events that correlate with the deterioration of the player game performance or complete abandonment of the game. The determination of the player performance level is determined by the user profile module that applies pre-defined criteria to establish the level of performance of the player based on the player's moves, number of wins, and other criteria, which may be specific to the game players. The determination of the correlation between the real time or near real time network performance and players' behavior (including game abandonment, performance deterioration, or other indicators) can take place, for instance, in the following ways. Module 12 may receive a stream of network-based events as they occur and store them in a database 20. Then, Network Pattern Acquisition module 12 may mine the network-based event data to determine network-based patterns that correlate with player game performance deterioration, abandonment of the game, or other pre-defined performance indicators, which also may be stored in a different segment of the database 20. Preferably, for this type of correlation to be determined efficiently, the system should know in advance the sensitivity of the game to certain types of network impairment issues. For example, it may be the case that only when the player is playing in a certain part of the game is the QoE sensitive to network delays (e.g., when the player is engaged in a battle with other players) and that, in all other cases, the game QoE is not sensitive to network performance so that the player game behavior in these cases may not be linked to network conditions, but to other factors such as the game server performance or user personal factors such as mood, context, and attention. This determination of correlation of game sensitivity to network performance can be performed in advance by testing the game under various network conditions in a controlled environment, such as a lab test-bed.

Alternatively or in addition to inferring gamers' performance degradation as a function of network conditions, the inverse may be performed. That is, the system may detect the degradation of the player performance (or the gamer's abandonment of the game) and then go back and check the network pattern acquisition database 20 to determine if it correlates with a problem in the network performance. The information stored in the network performance database 20 may be queried using traditional query languages or can be analyzed and mined using state of the art data analysis techniques.

The Player Behavioral Patterns Acquisition module 14 acquires player behavior events as collected by the game servers 24 and possibly by the user devices 26a, 26b, 26c. It may store these player behavior events in a database 21, and mine the event data to detect patterns of player behavior-based events that correlate with player abandonment of the game, which patterns it may store in a different segment of the database 21. Relevant player behavior-based events may include, for instance, how many times the player lost in the game and the frequency thereof, the time intervals between sessions of play, the duration of each session of play, etc.

Both the Network Pattern Acquisition module 12 and the Player Behavioral Pattern Acquisition module 14 learn patterns in each of their individual domains (i.e., network performance and user behavior, respectively) that correlate with a risk of player abandonment of the game. They may store the acquired network and user risk pattern data in one or more databases 20, 21 for use by the Composite Pattern Creation module 16 and the Pattern Detection module 18 as will be discussed further below.

The Composite Pattern Creation module 16 merges and correlates the two sets of patterns generated by modules 12 and 14 (and stored in databases 20 and 21) when appropriate to create composite patterns that include variables from both the game server/user device database 21 and the network database 20 that tend to be indicative of a player who is likely to abandon the game soon. In essence, the Composite Pattern Creation Module 16 looks for correlations between these two sets of patterns and, when it finds correlations, creates a composite pattern. Merely as one example, module 16 may determine from the network pattern data generated by module 12 and stored in database 20 and the player data generated by module 14 and stored in database 21 that, when there is network jitter during a session (the network data from module 12 and database 20) and the player loses the game (the player behavior data from module 14 and database 21), the player is likely to abandon the game and never come back. Thus, the Composite Pattern Detection module 16 may generate and store this combined pattern in a database 23 of combined patterns that are indicative of a likelihood of a player quitting the game (hereinafter termed a “risk pattern”).

The Pattern Detection module 18 detects player behavior-based and network-based events and patterns as they occur and compares them to the stored risk patterns and, when it detects that one of the risk patterns has occurred in connection with any particular player, alerts a Player Contact module 22 that will communicate with the player appropriately in an attempt to prevent his/her departure. Such communication may, for instance, involve messages providing the player with incentives to continue playing the game, such as free minutes of play, monetary awards, an award of currency within the game environment, an award of equipment within the game environment, free upgrades of equipment in the game environment, an award of a title in connection with the game, an award of an honor in connection with the play of the game, a public recognition of an achievement of the player in the game environment. Additionally or alternatively, the system could try to solve any network-related problem at the root of the risk pattern, such as requesting the network environment to switch the player to a different network with a higher QoS, transferring the player to a game sever that is closer to the player, and/or requesting the game server to decrease the amount of non-critical information sent to the player so his/her overall playing ability is improved.

The traffic events (e.g., measurements of traffic levels) may be obtained from multiple points 25 between the game server 24 and the players 26a-26c, including points close to the server, points in the last mile (wireless and wireline) to the player, and intermediary points, e.g., in the Internet 28, in the cloud 30, or in a circuit switched network (not shown). The network points 25 that provide the network event data to the system 10 could be any network function or node that records network performance data. Such nodes include eNodeBs, base stations, access points, MMEs (Mobility Management Entities), PGWs (Packet Gateways), SGWs (Serving Gateways), UEs, etc. Common network functions that gather such information include, for example, network management systems and quality assurance systems

The Network Pattern Acquisition module 12 may be manually preloaded, e.g., through a human/machine interface 34, with a set of events that are known or suspected to be of interest and thus do not need to be “learned” per se, such as “network jitter” and “network delay”, etc., that are defined in terms of basic network characteristics. These simple events comprise the “vocabulary” that is used to define the network patterns of interest. Other network characteristics can be learned using state of the art methods such as Support Vector Machine (SVM) and/or other commonly used methods, such as regression analysis methods, and then labeled by a human as corresponding to the above event names.

Similar learning techniques can be employed with respect to player behavior in the Player Behavior Acquisition module 14 as well as the Composite Pattern Creation module 18.

Player-related events and combined patterns of interest that are known or suspected also may be added directly to the databases 21, and 23 through a human/machine interface 34 without the use of learning techniques, just as discussed above in connection with network-related events.

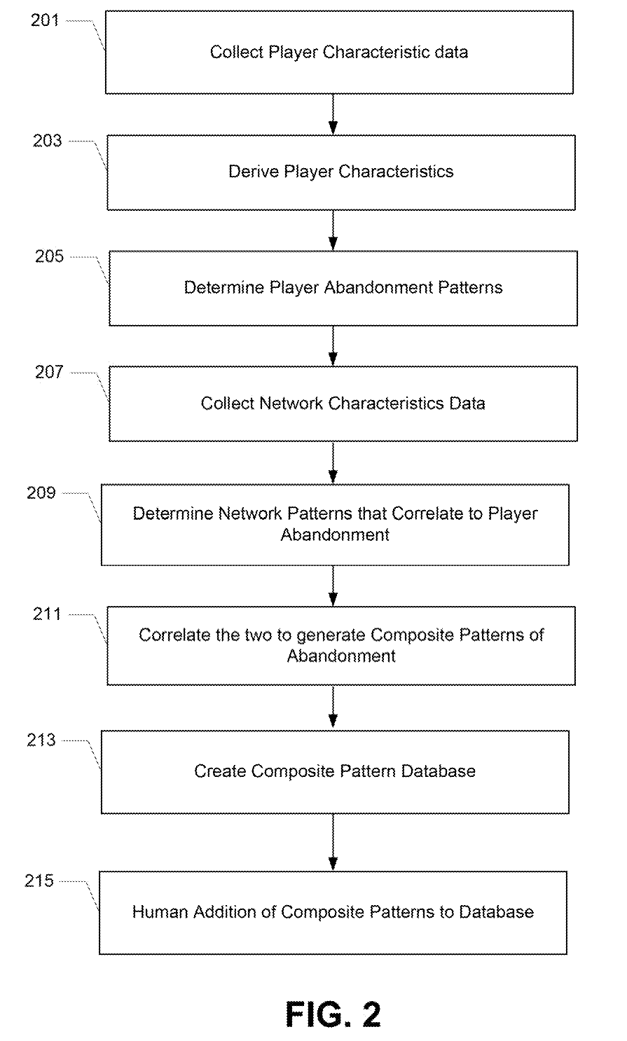

FIG. 2 is a flow diagram illustrating operation of the system for determining patterns of interest (patterns of network performance and/or player behavior that correlate to player abandonment) in accordance with one exemplary embodiment. The first part is the mining by the Player Behavioral Pattern Acquisition module 14 of the player behavior events stored in database 21 to detect patterns of player behavior that positively correlate with player departure and storing those patterns (e.g., also in database 21). As shown in FIG. 2, the database 21 is created by collecting information available from the game server 24 and/or user device(s) 26a-26c (201). As illustrated at 203, the raw information collected can first be used to derive player characteristics, such as how often the player plays the game, how long the player usually plays, the player's scores, the intensity of play, and other available attributes of player style.

In addition to deriving these attributes of the player (hereinafter play profile or player model), at 205, module 14 also may determine patterns of player behavior (e.g., sequence of events or circumstances) that correlate well with (i.e., tend to lead to) player abandonment of the game. Abandonment may be defined, for instance, in a relativistic manner, i.e., relative to the player's overall behavior. For example, if the player is typically engaged in playing the game at least once a day, this particular player not playing for over a week can be defined as abandonment. On the other hand, if the player only plays on weekends, abandonment for this player may instead be defined as not playing for two consecutive weeks.

For instance, one example of a pattern of behavior that might correlate well to a risk that a player is likely to abandon the game might be: (1) if the user is a frequent player (e.g., typically plays at least once a day) and (2) the last time the player played the player lost seven times, when usually the player does not lose more than once, and the player has not played for a week—then the player is at risk of abandoning the game.

As mentioned above in connection with network-based events of interest, for scalability and effectiveness, one may also preload the player behavior module 14 with a list of events deemed to be of interest without the need to “learn” them, such as “player losing the game” “player's play time”. These simple events are defined in terms of specific actions of the player during the game.

Module 12 can employ state of the art methods for data mining, such as the ones used by the CRM (Customer Relationship Management) industry which includes various analytics methods.

“Events of interest” may comprise simple events (e.g., a user/gamer just started playing a game, a user/gamer just lost a game, or network outage occurred at time T) as well as complex events, which are composed of multiple simple events. Examples of complex events may include a pattern of simple events such as “three consecutive losses of a game” or “network jitter” which entails several measurements of network connectivity. Events of interest are already known to have value as part of existing patterns to be detected. This means that these events already are part of existing patterns that the system has in its database. The definitions of these events of interest may be entered into the database by administrators who already know (e.g., from market research or off-line data mining performed outside of the presently described system) that these events correlate with an outcome that is of interest to them, e.g., customer getting frustrated and abandoning the game before completing it (e.g., before a win/loss is determined).

The concept of an “outcome” mentioned above also is a type of event of interest, namely, a type of event that is a result of prior events. The outcome of one pattern of events can serve as an event for another pattern. For example, when the players logs out of the game or his/her avatar disappears, the simple event “the player left the game” is detected. If at the same time the player did not conclude the game (no “win” or “loss” event was detected), then an outcome event “the player left the game prematurely” will be generated by a pattern that says “if the user left the game and no win/loss event was detected prior thereto, then generate the event user left the game prematurely”. This event can then be used by a pattern that says “if the user left a game prematurely three times in a row within one week, then contact the user with a message M1”, where M1 is a predefined message. As another example, a pattern may specify “if the user left the game prematurely and did not return to play the game within 3 days, then send message M2”.

The particular definitions of the patterns and the specific content of the messages to the customer is driven by the service provider's business model and, particularly, by how the provider wants to react to customer (e.g., gamer) behaviors. The system described here provided the mechanisms to determine the events of interest, define patterns, and define outcomes.

Likewise, at 209, the Network Pattern Acquisition module 12 collects network event data (207) and mines the raw network event data to determine patterns of network performance (e.g., sequence of events or circumstances) that correlate well with (i.e., tend to lead to) player abandonment of the game.

Next, at 211, the patterns of players developed in steps 201, 203, and 205 are then correlated with the patterns of network performance developed in steps 207 and 209 to develop patterns of combined network performance and player behavior that correlate with abandonment of the game.

This step of the process will then result in composite patterns, such as of the form:
{when there is jitter in the network traffic
   and
the player has lost the game more than three times when he usually never loses more than once a day
   then
the player is at risk of abandoning the game}

It should be understood that not all composite patterns that are indicative of imminent player abandonment (or other behaviors undesirable to the service provider), need be formed of a player behavior event and a network event. A composite pattern may be comprised of (1) one or more network-related events, (2) one or more player behavior events, (3) a combination of one or more network events and one or more player behavior events. For instance, one could easily imagine that players are likely to abandon a game if they lose 99% of the time regardless of network performance.

At 213, the discovered composite patterns of network-related events and/or player-related events are stored in the composite pattern database 23 (or library). These patterns will be later used to compare with actual play and/or network events and patterns to detect and/or predict players at risk of abandoning the game. The patterns can be organized in the database 23 in a variety of ways using available techniques for hashing and indexing.

The behavior patterns that are predictive of future undesirable behavior of a customer, whether learned by the system, learned by off-line data mining techniques or other means, or manually entered into the databases, may be generalized and used for other users of the same game and/or for users of other games. This may be performed in an automated fashion or may involve human intervention by the administrator to determine how to generalize the pattern. For example, if it is learned that, when members of a specific group of gamers lose a game three times in a row, there is a 70% likelihood of such players abandoning the game unless help/encouragement is provided, this pattern may be generalized (by a human administrator or automatedly) to other users and/or other games. It may be left up to a human administrator to determine the appropriate likelihood threshold (e.g., 70%) before converting a specific learned pattern that is true for some users in some games to a more general pattern to be applied to a more general group of users of that specific game or to a more general group of games.

Also, as previously noted and as shown at 215, administrators and other staff members (e.g., marketing staff) of the game providers may directly input into the composite database 23 additional patterns that they would like to be detected regardless of learning.

The collection of patterns stored in composite database 23 may be fed into the execution environment (e.g., the Pattern Detection module 18) whenever the collection of patterns is modified either by the automatic data mining and learning system or by the administrators and other staff.

Once risk patterns of network and player behavior are learned and added to the database 23, these patterns are then used in a live system to detect when such a pattern occurs in connection with an actual player during actual play. To be able to detect these situations, an information feed about the network behavior and the user behavior should be available to the system 10, preferably, in real time or close to real time. These feeds may come from network monitoring system(s) and user behavior monitoring system(s). These systems may be the same systems discussed above used to learn the patterns.

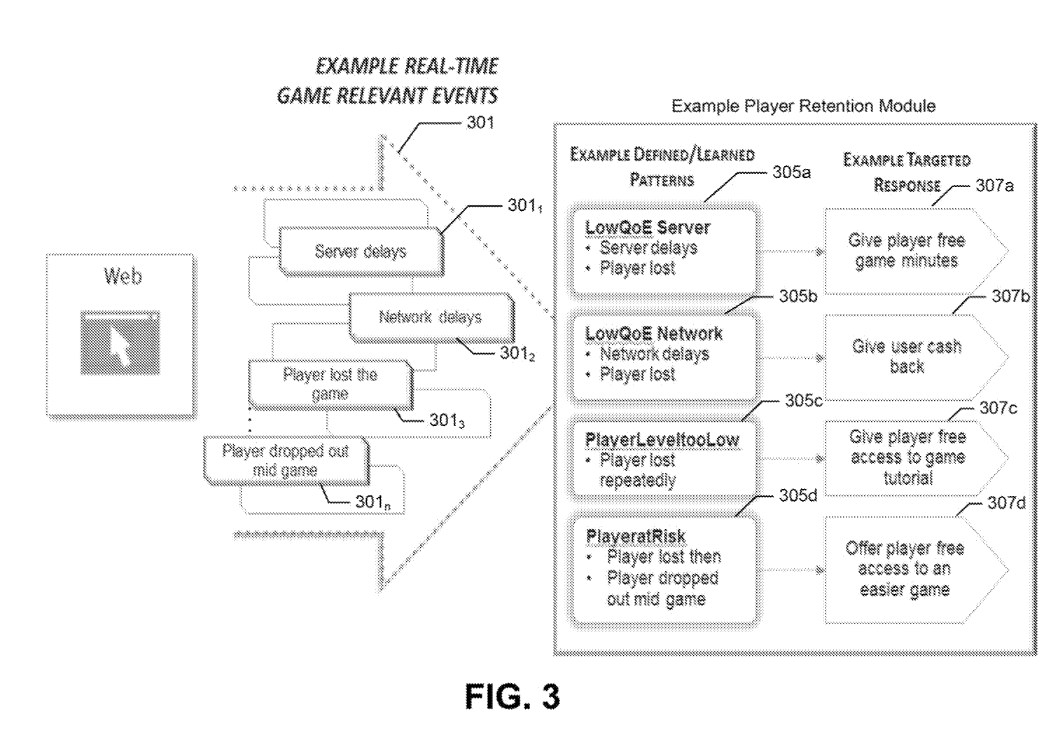

FIG. 3 illustrates an exemplary flow when event streams from both the network and the game monitoring systems are fed into the Player Retention System 10 and result in the detection of risk patterns followed by their associated actions to try to retain the player. The information streams can be fed in real time or can be stored and fed later in a “batch” mode.

Event data 301 from the information feeds that correspond to network and player events streams into the Pattern Detection module 18 of the Player Retention System 10. In one embodiment, each event stream 301 corresponds to an individual player and may include one or more sub-streams 301₃-301ₙ of player events (e.g., from the game server(s) and/or player device(s)) and one or more sub-streams 301₁-301_{b} of network events (from the network(s)). Since the game and the network may involve a very large number of events and since many of these events may not be relevant to the task of detecting players at risk of abandoning the game, the system may perform a pre-processing step (not shown in the figure) in which only events that are part of a list of events of interest are fed into the system 10. Merely as an example, a network event of interest could take the form of either network delay of any duration or network delay of a specific duration (e.g., at least 30 ms). In the former example, all network delay is reported to the system 10. In the latter case, only network delays of 30 ms or greater are reported to the system 10. Note, that “network delays of 30 ms” is a complex event that entails both a network delay and a duration of 30 ms or more and requires a rule (e.g., some predefined logic) to detect it. The list of events of interest may be predefined and/or learned on the fly and may be based on the events that were mentioned in connection with the pattern learning systems used to determine abandonment patterns (e.g., user losing the game, network jitter). These events are not necessarily the complete set of events that characterize the game or the network, but rather events of interest from a pre-defined class of events (e.g., network delays, player losing the game, etc.) that are relevant to a player's likelihood of abandoning the game (or performing any other action on non-action of interest to the game provider as described above).

The incoming events are matched against the aforementioned composite patterns 305a-305d that are indicative of a likelihood of imminent player abandonment of the game (which were generated and stored by the Comparative Pattern Creation module 16). Thus, for example, if the Network Pattern Acquisition system 20, which monitors ongoing network traffic, reports significant network delay (see sub-stream 301a in stream 301), then the first part of combined pattern 305b is partially satisfied. If it is later determined by the Player Behavioral Pattern Acquisition system that the player lost, then the complete composite pattern 305b is detected. At that point, in response, one of the corrective actions 307, e.g., corrective action 307b, is initiated.

For very high volume systems that involve tens or even hundreds of thousands of players, scalability of the Pattern Detection engine 18 may need to be addressed. In these type of cases, methods can be used, such as the ones described in Loeb et al (2004) [5], for preserving the state of the user between sessions to enable the efficient implementation of the process of detecting a pattern of events that happened over time.

An optional feature of the system is a Remedial Action Effectiveness module 29 (see FIG. 1) that determines if the remedial action that was taken had the intended effect. In other words, module 29 analyzes the player behavior-based events occurring after the remedial action is taken to determine if the remedial action statistically correlates with a reduced occurrence of player abandonment the game. For example, this module may determine whether a player that was offered extra play minutes did continue to play the game and for how long as compared to previous data for players that experienced similar conditions but were not offered such an incentive (or were offered a different incentive). This module 29 entails learning the effect of the various remedial actions on the various types of users and helping to fine tune rewards to target player types. For example, for experienced, high scoring players, adding free minutes or offering money back may be less effective than giving them special public honor or title.

Another optional feature of the system is a Fraud Detection module 27 that examines the behavior and the rewards given to players to detect possible fraud. That is, Fraud Detection module 27 may analyze player behavior-based events and the remedial actions to determine if players' behaviors correlate with patterns of player behavior adapted to reap the remedial actions, rather than adapted to play the game successfully in a normal manner. The patterns may be predetermined and input to the system manually. This system may have a pattern detection engine similar to the one shown in FIG. 3 in which it will keep track of how many times a particular player received a special remedial action (e.g., money, free minutes) and determine whether he/she is fraudulently losing in order to obtain awards. Again, these patterns may be learned by the system autonomously and/or defined by administrative staff.

The system and method described herein allow the providers of online games to detect at risk players in real time, near real time, or at predefined or ad-hoc intervals. The system may apply learned and defined pattern of events that indicate that the player may be at risk of leaving. These patterns are matched against incoming events that originate from multiple available sources including various points in the network(s), the game server(s), and the user device(s). The system can be offered by the game providers or by a third party that has access to the required information.

Similar systems and methods also may be used for other networked applications, such as streaming of content such as video (movies) to users' devices or home TVs. For example, imagine a situation where a movie is being streamed to a user's home TV. In this case, just like in the case of a networked game, the system and method described here can be used to determine if a user is at risk of discontinuing his/her movie subscription if the streaming quality is not adequate to support a reasonable QoE. Here too, users' behaviors, such as users needing to restart the movie because the video froze or users abandoning the movie mid-play due to poor quality, may be detected and correlated with users being at risk of cancelling their subscription and offered incentives to remain a subscriber.

It will further be understood that the events need not correlate directly with a complete cessation of consumption of the service (e.g., player abandonment). The system may be set up to detect patterns that correlate with any player behavior (or absence of behavior) that the service provider deems undesirable. Merely as one example, the events may correlate with merely a decrease in consumption of the service (as opposed to complete abandonment) or a decrease in or cessation of revenue generating activities by the player or consumer.

While the invention has been described in connection with embodiments that focus on risk patterns that comprise a composite or combination of network type events and gaming type events, the patterns of interest may comprise other types of events or patterns, including, for instance, only gaming type events/patterns and only network type events/patterns.

Furthermore, the system may include additional databases for storing intermediate data and additional processing modules for processing intermediate data as well as housekeeping type functions not expressly discussed herein.

### Exemplary Networks and Network Components

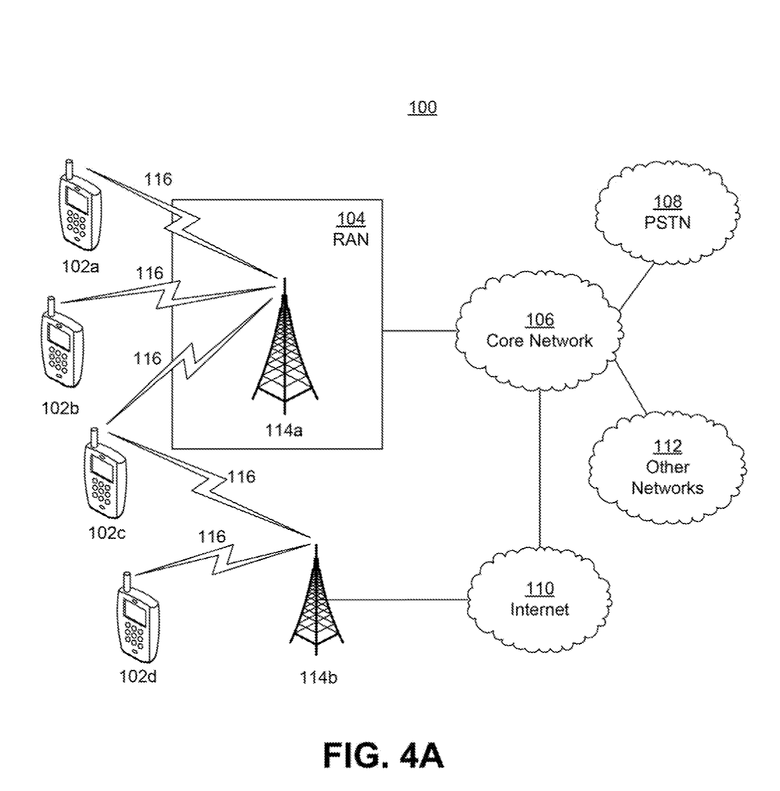

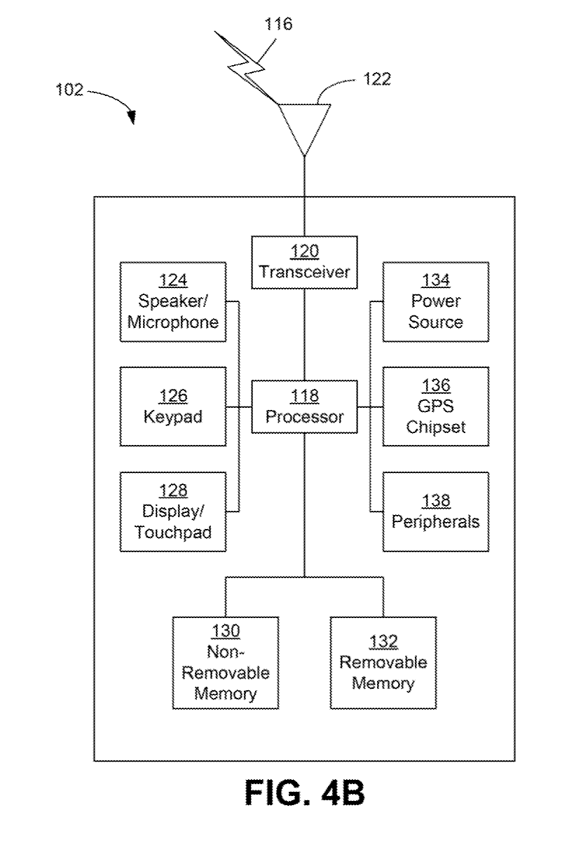

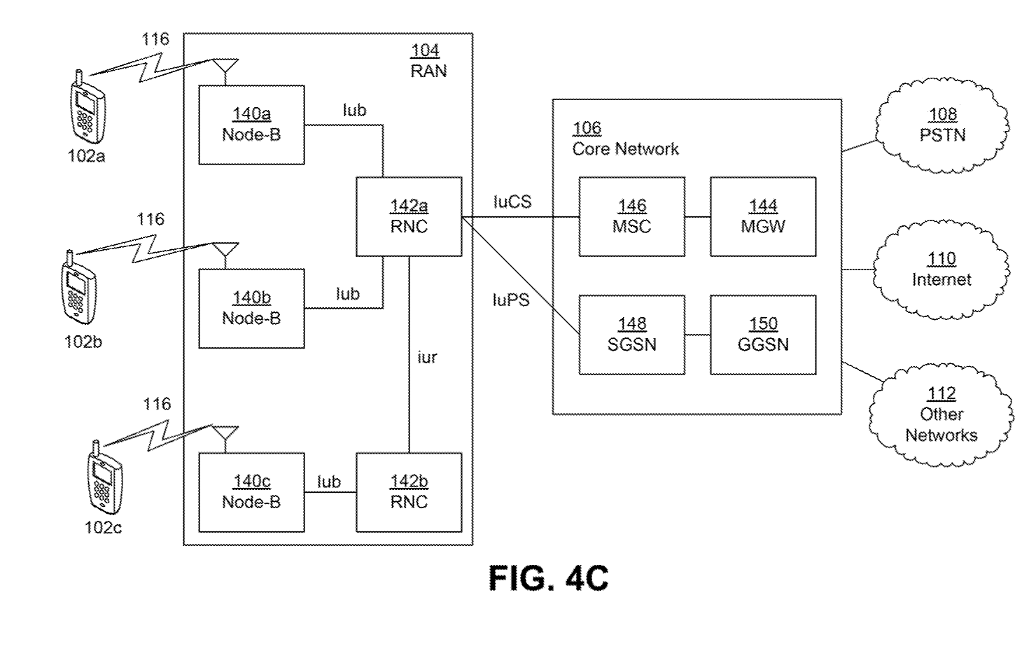

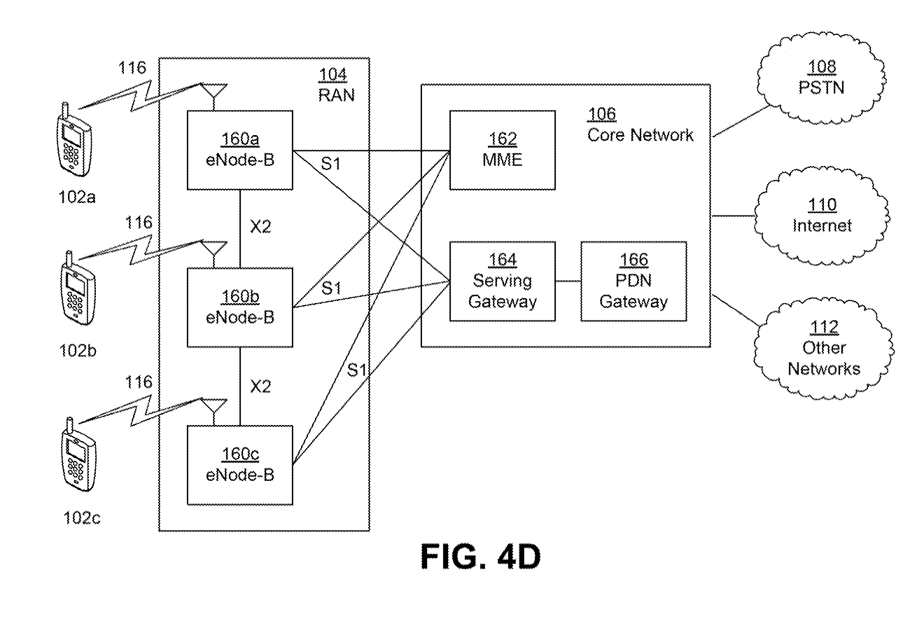

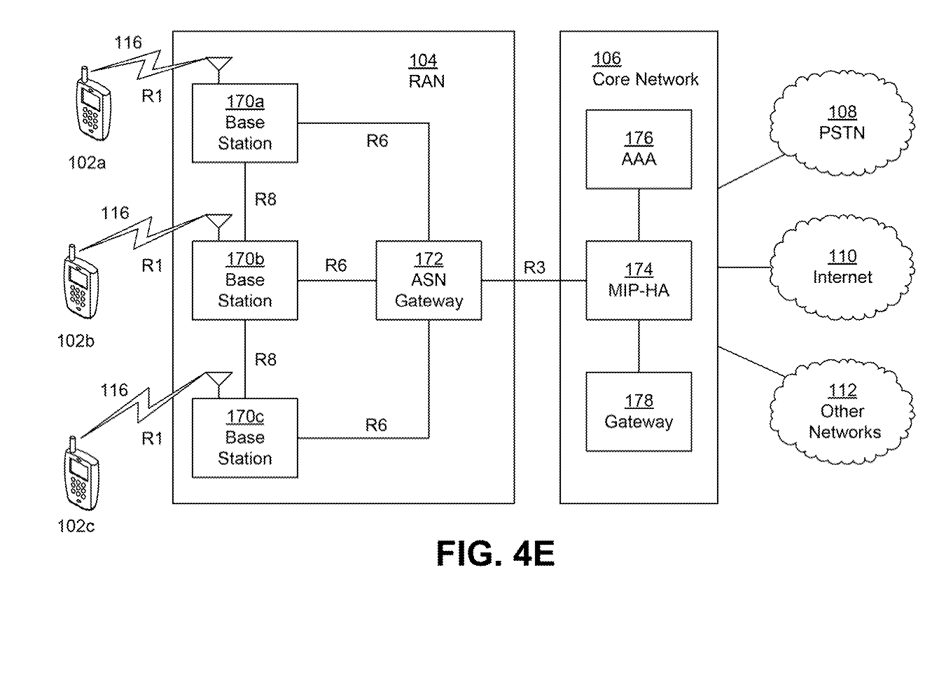

FIG. 4A is a diagram of an exemplary communications system 100 in connection with which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 4A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 4A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 4A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 4A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 4A may be configured to communicate with the base station 114a, which may employ a cellular-based radio technology, and with the base station 114b, which may employ an IEEE 802 radio technology.

FIG. 4B is a system diagram of an example WTRU 102. As shown in FIG. 4B, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 4B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 4B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality, and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 4C is a system diagram of the RAN 104 and the core network 106 according to an embodiment. As noted above, the RAN 104 may employ a UTRA radio technology to communicate with the WTRUs 102a, 102b, 102c over the air interface 116. The RAN 104 may also be in communication with the core network 106. As shown in FIG. 4C, the RAN 104 may include Node-Bs 140a, 140b, 140c, which may each include one or more transceivers for communicating with the WTRUs 102a, 102b, 102c over the air interface 116. The Node-Bs 140a, 140b, 140c may each be associated with a particular cell (not shown) within the RAN 104. The RAN 104 may also include RNCs 142a, 142b. It will be appreciated that the RAN 104 may include any number of Node-Bs and RNCs while remaining consistent with an embodiment.

As shown in FIG. 4C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 4C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 104 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 104 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 4D is a system diagram of the RAN 104 and the core network 106 according to another embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink and/or downlink, and the like. As shown in FIG. 4D, the eNode-Bs 160a, 160b, 160c may communicate with one another over an X2 interface.

The core network 106 shown in FIG. 4D may include a mobility management gateway (MME) 162, a serving gateway 164, and a packet data network (PDN) gateway 166. While each of the foregoing elements are depicted as part of the core network 106, it will be appreciated that any one of these elements may be owned and/or operated by an entity other than the core network operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode Bs 160a, 160b, 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

FIG. 4E is a system diagram of the RAN 104 and the core network 106 according to another embodiment. The RAN 104 may be an access service network (ASN) that employs IEEE 802.16 radio technology to communicate with the WTRUs 102a, 102b, 102c over the air interface 116. As will be further discussed below, the communication links between the different functional entities of the WTRUs 102a, 102b, 102c, the RAN 104, and the core network 106 may be defined as reference points.

As shown in FIG. 4E, the RAN 104 may include base stations 170a, 170b, 170c, and an ASN gateway 172, though it will be appreciated that the RAN 104 may include any number of base stations and ASN gateways while remaining consistent with an embodiment. The base stations 170a, 170b, 170c may each be associated with a particular cell (not shown) in the RAN 104 and may each include one or more transceivers for communicating with the WTRUs 102a, 102b, 102c over the air interface 116. In one embodiment, the base stations 170a, 170b, 170c may implement MIMO technology. Thus, the base station 170a, for example, may use multiple antennas to transmit wireless signals to, and receive wireless signals from, the WTRU 102a. The base stations 170a, 170b, 170c may also provide mobility management functions, such as handoff triggering, tunnel establishment, radio resource management, traffic classification, quality of service (QoS) policy enforcement, and the like. The ASN gateway 172 may serve as a traffic aggregation point and may be responsible for paging, caching of subscriber profiles, routing to the core network 106, and the like.

The air interface 116 between the WTRUs 102a, 102b, 102c and the RAN 104 may be defined as an R1 reference point that implements the IEEE 802.16 specification. In addition, each of the WTRUs 102a, 102b, 102c may establish a logical interface (not shown) with the core network 106. The logical interface between the WTRUs 102a, 102b, 102c and the core network 106 may be defined as an R2 reference point, which may be used for authentication, authorization, IP host configuration management, and/or mobility management.

The communication link between each of the base stations 170a, 170b, 170c may be defined as an R8 reference point that includes protocols for facilitating WTRU handovers and the transfer of data between base stations. The communication link between the base stations 170a, 170b, 170c and the ASN gateway 172 may be defined as an R6 reference point. The R6 reference point may include protocols for facilitating mobility management based on mobility events associated with each of the WTRUs 102a, 102b, 100c.

As shown in FIG. 4E, the RAN 104 may be connected to the core network 106. The communication link between the RAN 104 and the core network 106 may defined as an R3 reference point that includes protocols for facilitating data transfer and mobility management capabilities, for example. The core network 106 may include a mobile IP home agent (MIP-HA) 174, an authentication, authorization, accounting (AAA) server 176, and a gateway 178. While each of the foregoing elements are depicted as part of the core network 106, it will be appreciated that any one of these elements may be owned and/or operated by an entity other than the core network operator.

The MIP-HA 174 may be responsible for IP address management, and may enable the WTRUs 102a, 102b, 102c to roam between different ASNs and/or different core networks. The MIP-HA 174 may provide the WTRUs 102a, 102b, 102c with access to packet-switched networks, such as the Internet 110, to facilitate communications between the WTRUs 102a, 102b, 102c and IP-enabled devices. The AAA server 176 may be responsible for user authentication and for supporting user services. The gateway 178 may facilitate interworking with other networks. For example, the gateway 178 may provide the WTRUs 102a, 102b, 102c with access to circuit-switched networks, such as the PSTN 108, to facilitate communications between the WTRUs 102a, 102b, 102c and traditional land-line communications devices. In addition, the gateway 178 may provide the WTRUs 102a, 102b, 102c with access to the networks 112, which may include other wired or wireless networks that are owned and/or operated by other service providers.

Although not shown in FIG. 4E, it will be appreciated that the RAN 104 may be connected to other ASNs and the core network 106 may be connected to other core networks. The communication link between the RAN 104 the other ASNs may be defined as an R4 reference point, which may include protocols for coordinating the mobility of the WTRUs 102a, 102b, 102c between the RAN 104 and the other ASNs. The communication link between the core network 106 and the other core networks may be defined as an R5 reference, which may include protocols for facilitating interworking between home core networks and visited core networks.

### Embodiments

In one embodiment, a method is implemented of operating a game played by a multiplicity of players over a communication network comprising: storing patterns of events that correlate to a risk of a player abandoning game play of the game (Risk Patterns); detecting the occurrence of patterns of events associated with a player of the game during game play that correspond to any of the Risk Patterns; and, responsive to occurrence of a pattern of events associated with the during game play that corresponds to a Risk Pattern, taking an action adapted to prevent the player from abandoning game play.

The preceding embodiment may further comprise: detecting network-based events that occur during game play by the players of the game; detecting player behavior-based events that occur during game play by the players of the game; detecting patterns of game play by players of the game that correlate with player abandonment of the game (Abandonment Indicators); and analyzing the detected player behavior-based events, network-based events, and Abandonment Indicators to determine the Risk Patterns.

One or more of the preceding embodiments may further comprise wherein the Risk Patterns comprise sets of network-based events and/or player behavior events that correlate with Abandonment Indicators.

One or more of the preceding embodiments may further comprise wherein the detecting of Abandonment Indicators comprises detecting changes to game play behavior by a player of the game.

One or more of the preceding embodiments may further comprise wherein the action comprises offering an incentive for the player to continue playing the game.

One or more of the preceding embodiments may further comprise wherein determining Risk Patterns comprises determining network-based events, determining player behavior-based events, and generating a Risk Pattern that is a composite of network-based events and player behavior-based events.

One or more of the preceding embodiments may further comprise wherein the network-based events comprise network traffic patterns.

One or more of the preceding embodiments may further comprise wherein the network-based events comprise at least one of network latency, jitter, and packet loss.

One or more of the preceding embodiments may further comprise wherein the player behavior-based events comprise at least one of how many times the player lost in the game, the frequency of losses, the time intervals between sessions of play of the game, and the duration of each session of play of the game.

One or more of the preceding embodiments may further comprise wherein the action comprises transmitting a message to the player over the network.

One or more of the preceding embodiments may further comprise wherein the message transmitted to the player comprises at least one of an award of free minutes of game play, a monetary award, an award of currency within the game environment, an award of equipment within the game environment, an award of free upgrade of equipment within the game environment, an award of a title in connection with the game, an award of an honor in connection with the play of the game, a public recognition of an achievement of the player in the game environment.

One or more of the preceding embodiments may further comprise wherein the action comprises an action designed to reduce or eliminate a network-related event in the Risk Pattern that occurred.

One or more of the preceding embodiments may further comprise wherein the action comprises at least one of requesting the network to provide the player with a higher Quality of Service (Q0S), transferring the player to a different game server that is closer to the player than the game server with which the player was interacting when the Risk Pattern occurred, and requesting a game server to decrease the amount of information sent to the player during game play.

One or more of the preceding embodiments may further comprise wherein the detecting player behavior-based events comprises at least one of collecting data from devices on which players are playing the game and collecting data from a game server.

One or more of the preceding embodiments may further comprise wherein the detecting of network-based events comprises collecting data from the network.

One or more of the preceding embodiments may further comprise wherein the detecting of network-based events comprises pre-filtering the event data to limit the events detected to a predetermined list of events and the detecting of player behavior-based events comprises pre-filtering the event data to limit the events detected to a predetermined list of events.

One or more of the preceding embodiments may further comprise: detecting player behavior-based events occurring after the taking of the action; and analyzing the player behavior-based events occurring after the taking of the action to determine if the action taken correlates with a reduced occurrence of player abandonment of the game.

One or more of the preceding embodiments may further comprise analyzing player behavior-based events and the actions taken in response to Risk Patterns to determine if players' behaviors correlate with predetermined patterns of player behavior designated as fraudulent behavior.

In another embodiment, a method of providing a service over a communication network to a consumer of the service, the method comprising: detecting the occurrence of patterns of events during consumption of the service by a consumer that correspond to patterns of events that correlate to a risk of the consumer ceasing consumption of the service (Risk Patterns); and, responsive to occurrence of a pattern of events during consumption of the service that corresponds to a Risk Pattern, taking an action adapted to prevent the consumer from ceasing consumption of the service.

In another embodiment, an apparatus for retaining consumers of a service provided over a communication network comprising: a memory; a network pattern acquisition module configured to detect network-based events and determine and store in the memory patterns of network-based events that correlate to a risk of a consumer of the service decreasing consumption of the service; a consumer behavioral pattern acquisition module configured to detect consumer behavior-based events and determine and store in the memory patterns of consumer behavior-based events that correlate to a risk of a consumer of the service decreasing consumption of the service; a composite pattern creation module configured to analyze the stored patterns of network-based events that correlate to a risk of a consumer of the service decreasing consumption of the service and the stored patterns of player behavior-based events that correlate to a risk of a consumer of the service decreasing consumption of the service and determine and store composite patterns comprised of a plurality of network-based events and/or player behavior-based events that correlate to a risk of a consumer of the service decreasing consumption of the service (Composite Risk Patterns); a pattern detection module configured to detect the occurrence of patterns of events associated with a consumer of the service during consumption of the service that correspond to any of the Composite Risk Patterns; and a consumer contact module configured to take an action adapted to prevent the consumer from decreasing consumption of the service responsive to detection of an occurrence of a Composite Risk Pattern during consumption of the service.

The preceding embodiment may further comprise wherein the consumer contact module is configured to transmit a message comprising an incentive for the consumer to continue consuming the service.

One or more of the preceding embodiments may further comprise wherein the network-based events comprise at least one of network latency, jitter, and packet loss.

One or more of the preceding embodiments may further comprise wherein the service is a game and the consumer behavior-based events comprise at least one of how many times the consumer lost in the game, the frequency of losses, the time intervals between the consumer's sessions of play of the game, and the duration of each session of play of the game.

One or more of the preceding embodiments may further comprise wherein the action comprises at least one of requesting the network to switch the consumer to a different network with a higher Quality of Service (Q0S), transferring the consumer to a different server that is closer to the consumer than the server with which the consumer was interacting when the Risk Pattern was detected, and requesting a game server to decrease the amount of information sent to the player during game play.

One or more of the preceding embodiments may further comprise wherein the consumer behavioral pattern acquisition module collects the consumer behavior-based events from at least one of devices on which consumers are consuming the service, collecting data from a server providing the service, and collecting data from the network.

### CONCLUSION

Throughout the disclosure, one of skill understands that certain representative embodiments may be used in the alternative or in combination with other representative embodiments.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WRTU, UE, terminal, base station, RNC, or any host computer.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits.

The data bits may also be maintained on a computer readable medium including magnetic disks, optical disks, and any other volatile (e.g., Random Access Memory (“RAM”)) or non-volatile (“e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

No element, act, or instruction used in the description of the present application should be construed as critical or essential to the invention unless explicitly described as such. In addition, as used herein, the article “a” is intended to include one or more items. Where only one item is intended, the term “one” or similar language is used. Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Further, as used herein, the term “set” is intended to include any number of items, including zero. Further, as used herein, the term “number” is intended to include any number, including zero.

Moreover, the claims should not be read as limited to the described order or elements unless stated to that effect. In addition, use of the term “means” in any claim is intended to invoke 35 U.S.C. §112, ¶6, and any claim without the word “means” is not so intended.

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

A processor in association with software may be used to implement a radio frequency transceiver for use in a wireless transmit receive unit (WRTU), user equipment (UE), terminal, base station, Mobility Management Entity (MME) or Evolved Packet Core (EPC), or any host computer. The WRTU may be used m conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the invention has been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

### REFERENCES

The following references may have been cited in the text hereinabove and are incorporated herein in their entirety by reference.
[1] Chen K., Huang P., Lie C. (2009). Effect of Network Quality on Players Departure Behavior in Online Games. IEEE Transactions on Parallel and Distributed Systems
[2] Feng W., Brandt D., Saha D. (2007). A Long-Term Study of a Popular MMORPG NetGames '07, September 19-20, Melbourne, Australia
[3] Debeauvais T., Nardi B., Schiano D., Ducheneaut N., Yee N. (2011). If You Build It They Might Stay: Retention Mechanisms in World of Warcraft. FDG '11 Proceedings of the 6th International Conference on Foundations of Digital Games
[4] Chambers C., Feng W., Sahu S., Saha D., Brandt D. (2010) Characterizing On-Line Games IEEE/ACM Transactions on Networking.
[5] Loeb S. K., Kornacki M. E. (2004) Method and System for Capturing Streaming Data by an Actionable Information Engine. U.S. Pat. No. 6,725,287
[6] Chiang, C.-Y., Cichocki A, Erramilli S., McInerney K., Shur D., Loeb S. (2015). Prediction of Online Game Performance Degradation under Network Impairments. Proceedings of the IEEE CCNC, Jan. 9-12, 2015

1. A method of operating a game played by a multiplicity of players over a communication network, the method comprising:
storing patterns of events that correlate to a risk of a player abandoning game play of the game (Risk Patterns);
detecting the occurrence of patterns of events associated with a player of the game during game play that correspond to any of the Risk Patterns; and
responsive to occurrence of a pattern of events associated with the game play that corresponds to a Risk Pattern, taking an action adapted to deter the player from abandoning game play.

2. The method of claim 1 further comprising:
detecting network-based events that occur during game play by the players of the game;
detecting player behavior-based events that occur during game play by the players of the game;
detecting patterns of game play by players of the game that correlate with player abandonment of the game (Abandonment Indicators); and
analyzing the detected player behavior-based events, network-based events, and Abandonment Indicators to determine the Risk Patterns.

3. The method of claim 2 wherein the Risk Patterns comprise sets of network-based events and/or player behavior events that correlate with Abandonment Indicators.

4. The method of claim 1 wherein the detecting of Abandonment Indicators comprises detecting changes to game play behavior by a player of the game.

5. The method of claim 1 wherein the action comprises offering an incentive for the player to continue playing the game.

6. The method of claim 1 wherein determining Risk Patterns comprises determining network-based events, determining player behavior-based events, and generating a Risk Pattern that is a composite of network-based events and player behavior-based events.

7. The method of claim 6 wherein the network-based events comprise network traffic patterns.

8. The method of claim 7 wherein the network-based events comprise at least one of network latency, jitter, and packet loss.

9-10. (canceled)

11. The method of claim 1 wherein the action comprises transmitting a message to the player over the network, wherein the message transmitted to the player comprises at least one of an award of free minutes of game play, a monetary award, an award of currency within the game environment, an award of equipment within the game environment, an award of free upgrade of equipment within the game environment, an award of a title in connection with the game, an award of an honor in connection with the play of the game, a public recognition of an achievement of the player in the game environment.

12. (canceled)

13. The method of claim 1 wherein the action comprises at least one of requesting the network to provide the player with a higher Quality of Service (Q0S), transferring the player to a different game server that is closer to the player than the game server with which the player was interacting when the Risk Pattern occurred, and requesting a game server to decrease the amount of information sent to the player during game play.

14. (canceled)

15. The method of claim 1 wherein the detecting of network-based events comprises collecting data from the network.

16. The method of claim 2 wherein the detecting of network-based events comprises pre-filtering the event data to limit the events detected to a predetermined list of events and the detecting of player behavior-based events comprises pre-filtering the event data to limit the events detected to a predetermined list of events.

17. The method of claim 1 further comprising:
detecting player behavior-based events occurring after the taking of the action; and
analyzing the player behavior-based events occurring after the taking of the action to determine if the action taken correlates with a reduced occurrence of player abandonment of the game.

18-19. (canceled)

20. An apparatus for retaining consumers of a service provided over a communication network comprising:
a memory;
a network pattern acquisition module configured to detect network-based events and determine and store in the memory patterns of network-based events that correlate to a risk of a consumer of the service decreasing consumption of the service;
a consumer behavioral pattern acquisition module configured to detect consumer behavior-based events and determine and store in the memory patterns of consumer behavior-based events that correlate to a risk of a consumer of the service decreasing consumption of the service;
a composite pattern creation module configured to analyze the stored patterns of network-based events that correlate to a risk of a consumer of the service decreasing consumption of the service and the stored patterns of player behavior-based events that correlate to a risk of a consumer of the service decreasing consumption of the service and determine and store composite patterns comprised of a plurality of network-based events and/or player behavior-based events that correlate to a risk of a consumer of the service decreasing consumption of the service (Composite Risk Patterns);
a pattern detection module configured to detect the occurrence of patterns of events associated with a consumer of the service during consumption of the service that correspond to any of the Composite Risk Patterns; and
a consumer contact module configured to take an action adapted to deter the consumer from decreasing consumption of the service responsive to detection of an occurrence of a Composite Risk Pattern during consumption of the service.

21. The apparatus of claim 20 wherein the consumer contact module is configured to transmit a message comprising an incentive for the consumer to continue consuming the service.

22. The apparatus of claim 20 wherein the network-based events comprise at least one of network latency, jitter, and packet loss.

23. The apparatus of claim 20 wherein the service is a game and the consumer behavior-based events comprise at least one of how many times the consumer lost in the game, the frequency of losses, the time intervals between the consumer's sessions of play of the game, and the duration of each session of play of the game.

24. The apparatus of claim 20 wherein the action comprises at least one of requesting the network to switch the consumer to a different network with a higher Quality of Service (Q0S), transferring the consumer to a different server that is closer to the consumer than the server with which the consumer was interacting when the Risk Pattern was detected, and requesting a game server to decrease the amount of information sent to the player during game play.

25. The apparatus of claim 20 wherein the consumer behavioral pattern acquisition module collects the consumer behavior-based events from at least one of devices on which consumers are consuming the service, a server providing the service, and the network.
